(19) United States
(12) Patent Application Publication
(10) Pub. No.: US 2026/0194877 A1
(43) Pub. Date: Jul. 9, 2026

(54) ENCODER POSITION DETECTION USING LED DRIVER FAULT DETECTION

(71) Applicant: Haier US Appliance Solutions, Inc., Wilmington, DE (US)

(72) Inventors: Robert Turner White, Louisville, KY (US); Richard Gary Woodham, JR., Taylorsville, KY (US)

(21) Appl. No.: 19/014,456

(22) Filed: Jan. 9, 2025

(51) Int. Cl. G05B 19/042; D06F 34/04; D06F 34/05; D06F 34/30; G01D 5/14; G01D 5/252

(52) U.S. Cl. CPC G05B 19/042; D06F 34/04; D06F 34/05; D06F 34/30; G01D 5/14; G01D 5/252; G05B 2219/25257

(57) ABSTRACT

A laundry appliance and corresponding method are provided. The laundry appliance includes a cabinet including a controller operably coupled to a user interface panel via other features, and communicatively coupled to an operational component. The controller is configured to receive a user input for selecting an operational cycle for operating the operational component. The resulting position of an input selector with a position encoder as set by user input is encoded as a grey code position using open and short fault detection of an LED matrix driver associated with the controller. An associated microcontroller requests the matrix driver to check for opens and shorts. Voltages on specific pins are read by the matrix driver to detect an open or short condition. The combinations of open and short conditions on designated pins determines the corresponding position of the user input to the associated controller.

### FIELD OF THE INVENTION

The present subject matter relates generally to laundry appliances. The present subject matter relates particularly to structures and methods for controlling laundry appliances.

### BACKGROUND OF THE INVENTION

Controls for consumer appliances are often located on an outwardly facing side or surface of the unit. For example, controls may be on a front, top, or other side surface, sometimes in a location designed to make efficient use of space both internal to the appliance and external to the appliance.

In some instances, an appliance (for example, such as a laundry appliance or dryer appliance or cooktop appliance) includes a cabinet including a controller operably coupled to a user interface panel and an operational component. The controller is communicatively coupled to the user interface and is configured to receive a user input for operating the operational component. The resulting position of the controller is set by user input. The position is encoded as a grey code position associated with the controller.

In some instances, in order to read an encoder position, each “bit” of its “grey code” must be pulsed. Achieving synchronization between the pulses and reads is difficult and burdensome to an associated microcontroller which has to handle responsibility of such exercise. External components are nonetheless often needed to actually carry out the pulsing of the encoder to retrieve each bit of grey code.

In some instances, pulsing is not strictly necessary. But the simplest solution in such instances would require the microcontroller to have a pin directly tied to or associated with each bit. Such need may be difficult to satisfy because microcontroller pins are often scarce, which could render such technical approach not possible.

Accordingly, an appliance and methods for controlling an appliance system that address one or more of the challenges noted above would be beneficial and advantageous.

### BRIEF DESCRIPTION OF THE INVENTION

Aspects and advantages of the invention will be set forth in part in the following description, or may be obvious from the description, or may be learned through practice of the invention.

An aspect of the present disclosure is directed to an appliance, for example such as a laundry appliance. An exemplary laundry appliance and corresponding method are provided. The exemplary laundry appliance includes a cabinet including a controller operably coupled to a user interface panel via other features, and communicatively coupled to an operational component. The controller is configured to receive a user input for selecting an operational cycle for operating the operational component. The resulting position of an input selector with a position encoder as set by user input is encoded as a grey code position using open and short fault detection of an LED matrix driver associated with the controller. An associated microcontroller requests the matrix driver to check for opens and shorts. Voltages on specific pins are read by the matrix driver to detect an open or short condition. The combinations of open and short conditions on designated pins determines the corresponding position of the user input to the associated controller.

Another aspect of the present disclosure is directed to an appliance system, for example such as a laundry system. The laundry system includes a first laundry appliance including a cabinet further including a controller operably coupled to a user interface panel and an operational component. The controller is configured to receive a user input for operating the operational component in a determined operational cycle, which is determined by using encoder position detection accomplished through LED driver fault detection. In various embodiments, and depending on associated circuitry particulars, the criteria for determining an open or short condition can be adjusted accordingly, to distinguish between the respective conditions in the context of that embodiment.

Stated in other terms, presently disclosed such matter relates at least in part to detecting encoder “grey code” position using open short fault detection of an LED matrix driver.

Another exemplary embodiment of presently disclosed subject matter relates to an appliance, comprising a cabinet, an operational component, a controller, and a matrix driver. The cabinet preferably comprises a user interface panel, the user interface panel comprising a display and an input selector. The operational component is preferably configured to perform an operational cycle. The controller is communicatively coupled to the operational component, the controller configured to receive a user input for operating the operational component. The matrix driver is preferably operably coupled to the input selector and communicatively coupled to the controller, and configured to receive a user input for operating the operational component and to provide to the controller a signal corresponding to the user input.

Another exemplary embodiment of presently disclosed subject matter relates to a laundry appliance, preferably comprising a cabinet, the cabinet comprising a user interface panel, the user interface panel comprising a display and an input selector; an operational component configured to perform an operational cycle; a controller communicatively coupled to the operational component, the controller configured to receive a user input for operating the operational component; and an LED matrix driver operably coupled to the input selector and communicatively coupled to the controller, and configured to receive a user input for operating the operational component and to provide to the controller a signal corresponding to the user input. Further preferably, the input selector is configured to assume a rotational position based on the user input, and includes a position encoder with selected pins configured to output open or short fault detection voltages on the selected pins depending on the rotational position based on the user input; and the LED matrix driver is configured to read voltages on the selected pins of the position encoder to detect respective open or short conditions, and to output a grey code based on the detected conditions, which grey code indicates a unique rotational position corresponding with a selected operational cycle to be performed.

It is to be understood that the presently disclosed subject matter equally relates to associated and/or corresponding methodologies. One exemplary such method relates to method a method for controlling an appliance, comprising providing an appliance having a cabinet, the cabinet comprising a user interface panel, the user interface panel comprising a display and an input selector, an operational component configured to perform an operational cycle, a controller communicatively coupled to the operational component, and a matrix driver operably coupled to the input selector and communicatively coupled to the controller, receiving a user input at the input selector for operating the operational component; and using the matrix driver to detect a rotational position of the input selector corresponding with an operational cycle selected by the user input, and to output to the controller a signal corresponding to the user input.

Other example aspects of the present disclosure are directed to systems, apparatus, tangible, non-transitory computer-readable media, user interfaces, memory devices, and electronic devices for appliances. To implement methodology and technology herewith, one or more processors may be provided, programmed to perform the steps and functions as called for by the presently disclosed subject matter, as will be understood by those of ordinary skill in the art.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side view of an appliance system that includes an exemplary dryer appliance paired with an exemplary washing machine appliance in accordance with an exemplary embodiment of the present disclosure.

FIG. 2 provides an exploded, perspective view of the appliance system of FIG. 1 depicting a door of the washing machine appliance in an open position and the dryer appliance shown partially cutaway.

FIG. 3 provides a schematic block diagram of an exemplary arrangement of pins of an exemplary encoder in accordance with an exemplary embodiment of the present disclosure.

FIG. 4 provides a table-form chart of rotational angle positions respectively represented by a grey code implemented with a four pin (or terminal) plus common terminal arrangement of an exemplary encoder in accordance with an exemplary embodiment of the present disclosure.

FIG. 5 provides a schematic block diagram of one exemplary cycle selector encoder and shift register and an exemplary microcontroller of an exemplary prior art arrangement.

FIG. 6 provides a schematic block diagram of the communication relationship of an exemplary matrix drive, and exemplary encoder, and an exemplary microcontroller in accordance with exemplary aspects of the present disclosure.

FIG. 7 provides a schematic block diagram of an exemplary arrangement of CS pins of an exemplary encoder in accordance with an exemplary embodiment of the present disclosure.

Repeat use of reference characters in the present specification and drawings is intended to represent the same or analogous features, elements, or steps of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

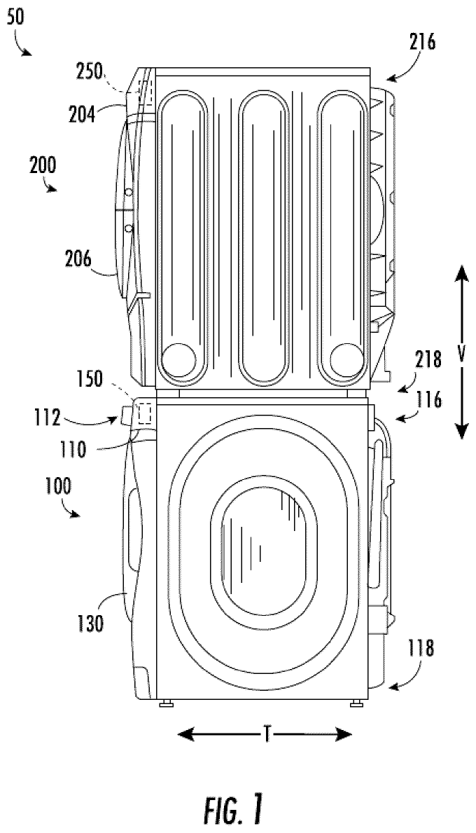

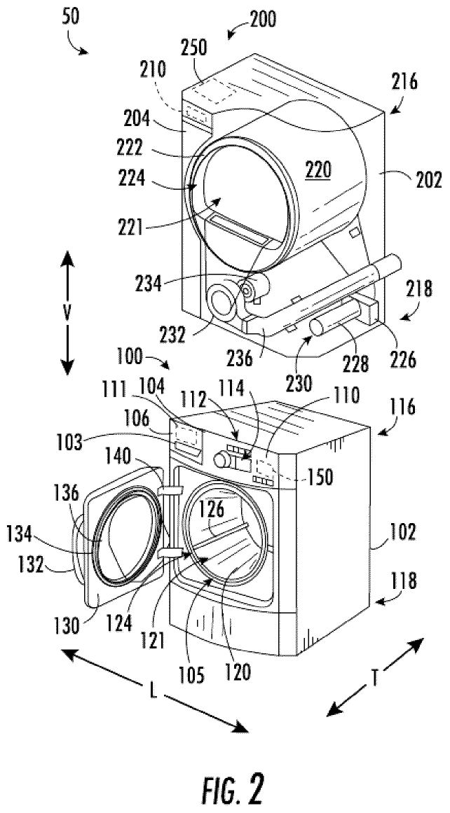

FIGS. 1 and 2 provide an exemplary appliance system (or assembly) 50 in accordance with an exemplary embodiment of the present subject matter. FIG. 1 provides a side elevation view of appliance system 50. FIG. 2 provides an exploded perspective view of appliance system 50. As shown, appliance system 50 includes a first appliance 100 and a second appliance 200. It should be understood that the presently disclosed subject matter is not limited to use with any particular appliance or arrangement of appliances. For example, individual appliances or paired appliances (either side-by-side or stacked) may be practiced with the presently disclosed subject matter.

For this particular exemplary embodiment, the first appliance 100 is a washing machine appliance and the second appliance 200 is a dryer appliance stacked thereon. Generally, appliance system 50 defines a vertical direction V, a lateral direction L, and a transverse direction T. The vertical direction V, lateral direction L, and transverse direction T are mutually perpendicular and form an orthogonal direction system.

The first appliance includes an exemplary front panel 104, including a first user interface 110, and a second user interface 111 positioned at drawer 106, in accordance with an exemplary embodiment of the present subject matter.

The exemplary first appliance 100 depicted in FIGS. 1 and 2 is a horizontal axis washing machine appliance. However, while described in the context of a specific embodiment of horizontal axis washing machine appliance arranged in a stacked fashion with the second appliance 200 forming a dryer appliance, using the teachings disclosed herein, it will be understood that the horizontal axis washing machine appliance is provided by way of example only. Other washing machine appliances having different configurations, different appearances, and/or different features may also be utilized with the present subject matter as well. Likewise, user interfaces may be positioned in conjunction with various surfaces of an appliance cabinet, such as the top, front, or other surface of an appliance cabinet.

First appliance 100 per the presently illustrated exemplary embodiment has a cabinet 102 with a drum 120 rotatably mounted therein. Cabinet 102 extends between a top 116 and a bottom 118, e.g., along the vertical direction V. Cabinet 102 also extends between a first side and a second side, e.g., along the lateral direction L, and between a front portion and a rear portion, e.g., along the transverse direction T. An operational component forming a motor (not shown) is in mechanical communication with drum 120 in order to selectively rotate drum 120. For example, drum 120 may selectively rotate during an agitation or a rinse cycle of the washing machine appliance. In various embodiments, drum 120 defines a wash chamber 121 that is configured for receipt of articles for washing. Ribs 126 extend from drum 120 into wash chamber 121. Ribs 126 may assist with agitation of articles disposed within wash chamber 121 during operation of washing machine appliance 100. For example, ribs 126 may lift articles disposed in drum 120 during rotation of drum 120. Drum 120 also defines a plurality of holes 124. Holes 124 are configured to permit a flow of wash fluid between an interior of drum 120 and an exterior of drum 120 (e.g., between drum 120 and a tub of washing machine appliance 100).

Referring to FIGS. 1 and 2, cabinet 102 of first appliance 100 has a front panel 104. A drawer 106 is slidably mounted within front panel 104. For instance, drawer 106 may include rollers, rails, or other devices generally understood for facilitating articulation of a drawer from a cabinet. Drawer 106 includes a reservoir 101 for receiving dry or fluid detergent and/or other fluid additives (e.g., fabric softener or bleach) and directs the contents to wash chamber 121 during operation of first appliance 100. Front panel 104 forms an opening 107 into which the drawer 106 is slidably mounted within the cabinet 102 at the front panel 104. Drawer 106 may include a handle 103 at which a user may articulate the drawer 106 into and out of the cabinet 102 (e.g., articulate along transverse direction T).

Front panel 104 defines a loading opening 105 that permits user access to wash chamber 121 of drum 120. A door 130 is rotatably mounted to front panel 104 with a hinge 140. Door 130 permits selective access to wash chamber 121. A window 136 in door 130 permits viewing of wash chamber 121, e.g., during operation of first appliance 100. Door 130 also includes a handle 132 that a user may pull when opening and closing door 130. Latch striker 134 is configured for selectively securing door 130 to a latch (not labeled) when door 130 is in a closed position.

Front panel 104 also includes a first user interface panel 110. First user interface panel 110 includes a plurality of input selectors 112 and a display 114. Display 114 of first user interface panel 110 indicates selected features, a countdown timer, and/or other items of interest to appliance users. In some embodiments, display 114 is a touchscreen, such as e.g., an LCD touchscreen. Input selectors 112 and display 114 collectively provide an interface for users to provide user inputs for operator selection of machine cycles and features. Particularly, in accordance with exemplary aspects of the present disclosure, input selectors 112 and display 114 of first user interface panel 110 collectively provide an interface for users to provide user inputs for operator selection of machine cycles (e.g., washing machine cycles and modes) and features of first appliance 100.

In particular, one example of an input selector 112 may more specifically comprise a rotatable knob or control input 113 which may be provided for receiving user input. In other words, the knob 113 may be rotated by a user to a selected location or rotational position, to direct or control appliance 100 to perform a selected operational cycle.

Drawer 106 includes a second user interface panel 111. Second user interface panel 111 may include a plurality of input selectors and a display. Such display of second user interface panel 111 may indicate selected features, a countdown timer, and/or other items of interest to appliance users. In some embodiments, such display may be a touchscreen, such as e.g., an LCD touchscreen. The input selectors and display of the second user interface panel 111 collectively provide an interface for users to provide user inputs for operator selection of machine cycles and features. Particularly, in accordance with exemplary aspects of the present disclosure, second user interface panel 111 may facilitate collectively providing an interface for users to provide user inputs (e.g., second user inputs) for operator selection of machine cycles (e.g., dryer cycles and modes) and features of second appliance 200.

In some instances, a portion of an exemplary embodiment of the first panel 104 of the first appliance 100 is provided with drawer 106 to be removed for access to a data port (not shown). First appliance 100 may include a data port configured to transmit user inputs (e.g., second user inputs) or signals from the second user interface panel 111 to the controller 250 at the second appliance 200. Such a data port may include a communications bus, such as a telecommunications cable (e.g., an ethernet cable or other appropriate communications interface with the data port). The communications bus is operably coupled to second interface panel 111 through drawer 106 to permit transmission of user inputs or signals received at the second interface panel 111 to controller 250 at second appliance 200. The data port may include any suitable wired or wireless communications apparatus, such as a registered jack (RJ), ethernet port, or other telecommunications port or module. The communications bus may include any suitable connection to the data port, such as a wired connection.

Operation of first appliance 100 is controlled by a controller 150 that is communicatively coupled with various components of first user interface panel 110. In this way, when a user manipulates input selectors 112 or 113 or display 114 to select machine cycles and features (e.g., washing machine cycles and modes), controller 150 operates the various components of first appliance 100 to execute selected machine cycles and features.

Operation of second appliance 200 is controlled by a controller 250 that is communicatively coupled with various components of second user interface panel 111 through the data port. In this way, when a user manipulates input selectors or display 115 to select machine cycles and features (e.g., dryer cycles and modes), controller 250 operates the various components of second appliance 200 to execute selected machine cycles and features.

In some example embodiments, controller 150, 250 may include one or more memory devices and one or more processing devices, such as general or special purpose microprocessors operable to execute programming instructions or micro-control code associated with operating first appliance 100 and second appliance 200, respectively. The memory device (i.e., memory) may represent random access memory, such as e.g., DRAM, or read only memory such as EEPROM or FLASH. In some embodiments, the one or more processing devices execute programming instructions stored in memory. The memory may be a separate component from the processor or may be included onboard within the processor. The memory can store information accessible to processing device, including instructions that can be executed by processing device. Optionally, the instructions can be software or any set of instructions that, when executed by the processing device, cause the one or more processing devices to perform operations. For some embodiments, the instructions include one or more software packages configured to operate first appliance 100 and second appliance 200 and interpret one or more electrical signals. For example, the instructions may include a software package configured to execute commands based on feedback from user controls, such as user inputs or signals. Controller 150, 250 may be positioned in a variety of locations throughout appliances 100, 200, respectively.

As illustrated in FIG. 2, controller 150 is located proximate first user interface panel 110 of first appliance 100. In such embodiments, input/output (“I/O”) signals may be routed between controller 150 and various operational components of first appliance 100.

Referring still to FIG. 2, controller 250 is located at cabinet 202 of second appliance 200. In such embodiments, input/output (“I/O”) signals may be routed between controller 250 and various operational components of second appliance 200.

First appliance 100 may be operated in a wash cycle in the following exemplary manner. Laundry items are loaded into wash chamber 121, and washing operation is initiated through operator manipulation of input selectors 112. Drum 120 is filled with water, and detergent and other additives are dispensed from drawer 106 to the wash chamber 121 to form a wash fluid with water at the drum 120. One or more valves (not shown) can be controlled by first appliance 100 to fill drum 120 to the appropriate level for the amount of articles being washed. Once drum 120 is filled with fluid to the desired level, the laundry items within wash chamber 121 are agitated with rotation of drum 120 and ribs 126 for cleansing the laundry items.

After the agitation phase of the wash cycle is completed, wash fluid is drained from drum 120. Laundry articles can then be rinsed by adding fluid to drum 120, depending on the cleaning cycle selected by a user. Ribs 126 and rotation of drum 120 may provide agitation within wash chamber 121. One or more spin cycles may also be used. A spin cycle may be applied after the wash cycle and/or after the rinse cycle in order to wring wash fluid from the articles being washed. During a spin cycle, drum 120 is rotated at relatively high speeds.

The exemplary second appliance 200 of appliance system 50 depicted in FIGS. 1 and 2 is a front load or horizontal axis dryer appliance. However, while described in the context of a specific embodiment of horizontal axis dryer appliance arranged in a stacked fashion or manner with first appliance 100, using the teachings disclosed herein it will be understood that horizontal axis second appliance 200 is provided by way of example only. Other dryer appliances having different configurations, different appearances, and/or different features may also be utilized with the present subject matter as well.

Second appliance 200 has a cabinet 202 and a drum 220 rotatably mounted therein. Drum 220 is mounted for rotation about a substantially horizontal axis (i.e., an axis that is substantially orthogonal to the vertical direction V). An operational component forming a motor (not shown) is in mechanical communication with drum 220 in order to selectively rotate drum 220. For example, drum 220 may selectively rotate during a drying cycle of second appliance 200. Drum 220 defines a drying chamber 221 that is configured for receipt of articles for drying. Tumbling ribs may extend from drum 220 into drying chamber 221 for tumbling of laundry articles during a drying cycle. Drum 220 is generally cylindrical in shape, having an imperforate outer cylindrical wall and a front flange or wall 222 defining an opening 224 to drum 220 for loading and unloading of laundry articles.

Cabinet 202 extends between a top 216 and a bottom 218, e.g., along the vertical direction V. Cabinet 202 also extends between a first side and a second side, e.g., along the lateral direction L, and between a front portion and a rear portion, e.g., along the transverse direction T. Cabinet 202 of dryer appliance 200 has a front panel 204. Various drawers may be slidably mounted within front panel 204. A door 206 (FIG. 1) is rotatably mounted to front panel 204, e.g., with a hinge. Door 206 permits selective access to drying chamber 221. A window in door 206 permits viewing of drying chamber 221, e.g., during operation of second appliance 200. Door 206 also includes a handle that a user may pull when opening and closing door 206. A latch assembly is configured for selectively securing door 206 in a closed position.

Furthermore, drum 220 includes a rear wall rotatably mounted with cabinet 202 by a suitable bearing. The rear wall of drum 220 defines a plurality of holes or apertures that receive hot air that has been heated by an electric heater 226 in communication with an air supply duct 228 and duct inlet 230. The air is moved from drum 220 by a blower fan 232, which is driven by a blower motor 234. The air may pass through a screen filter configured for trapping lint particles. As the air passes through the screen filter, the air enters a trap duct seal and is passed out of the clothes dryer through an exhaust duct 236. After the clothing articles have been dried, they are removed from drum 220 via opening 224.

In some embodiments, front panel 204 may include a third user interface panel 210. The third user interface panel 210 may include a plurality of input selectors and/or a display, such as described above in regard to user interface panel 111, including rotatable knob 113 (not reshown at panel 210, for clarity of illustration). The display of the user interface panel of second appliance 200 may indicate selected features, a countdown timer, and/or other items of interest to appliance users. In some embodiments, the display is a touchscreen, such as e.g., an LCD touchscreen. The input selectors and display may collectively provide an interface for users to provide user inputs for operator selection of machine cycles and features. For this embodiment, operation of dryer appliance 200 is controlled at least in part by controller 250. In some exemplary embodiments, in response to user manipulation of second user interface panel 111, user inputs or signals are communicated from the second user interface panel 111 at the first appliance 100 and generates and communicates a control command that is routed to controller 250, which in turn causes one or more operational components of second appliance 200 to execute selected machine cycles and features. In still some embodiments, in response to user manipulation of second user interface panel 111, user inputs or signals are communicated from the second user interface panel 111 at the first appliance 100 and generates and communicates a control command that is routed to controller 150 of first appliance 100, which in turn is routed to controller 250 of second appliance 200, and causes one or more operational components of second appliance 200 to execute selected machine cycles and features.

In some embodiments, however, second appliance 200 does not include a user interface panel (i.e., second appliance 200 does not include third user interface panel 210). For instance, second user interface panel 111 at first appliance 100 may remove a need for a user interface panel positioned at the second appliance 200. However, in various embodiments, second user interface panel 111 may permit positioning of controls for the second appliance 200 at the first appliance 100, such as to position control more accessibly along the vertical direction V. In still various embodiments, second user interface panel 111 at drawer 106 may provide a repair, replacement, or upgrade feature for a user interface panel at the second appliance 200 without requiring removal or disassembly of the user interface panel at the second appliance 200. In yet other embodiments, second appliance 200 includes only a controller 250 without a display or input selectors.

Communication features referenced herein may be configured as any suitable wired or wireless communications module. For instance, communication features in some instances may be configured to emit and/or receive one or more signals (e.g., according to a predetermined pattern). For example, a wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between first appliance 100 and second appliance 200.

In various embodiments, the first appliance 100 may include a power supply module, which may include any appropriate power supply device, such as configured to provide voltage/current for powering a user interface. For instance, the power supply module may include a battery, a capacitor, a driving system, or other component configured to provide, manipulate, or actuate a supply of voltage/current to a device. The power supply module may further be operably connected to various components of the first appliance 100, as may generally be understood, for powering a user interface, controller, or operational components.

In still various instances, embodiments provided herein may improve connectivity among a plurality of appliances without requiring remote computing devices, such as smartphones, tablets, laptop computers, or other devices.

Using the open short detection internal to the matrix driver, synchronization can be achieved and the encoder position can be read. In this example, the microcontroller simply requests that the matrix driver check for opens and shorts. Such request can be made periodically, such as through an I2C bus (i.e., the Inter-Integrated Circuit bus—two-wire, bidirectional, serial data bus, standard interface for communication between devices and sensors, using a controller to communicate with other associated devices). The matrix driver returns the open and short locations through the same I2C bus.

In one present exemplary embodiment, the CS (chip select) nets are the “low” sides of the matrix driver and SW (switch) are the “high” sides. The voltage on the CS pins is read by the matrix driver and used to detect the open or short condition. In some embodiments, the polarity of the encoder pins can be reversed from the original shift register implementation, so the common pin becomes the “high” side while the remaining pins are the “low” side. The original encoder polarity is still valid for some embodiments, but in some instances can be changed (reversed) as indicated to accommodate various layout needs.

The detection conditions are simple and determined by the matrix driver. The following conditions are an example: a “short” condition is detected if voltage at the CS pin is greater than the voltage supplied to the matrix drive minus 1V.

In other words: Short=VCS greater than VCC-1V

An “open” condition is detected if voltage at the CS pin is less than 0.1V.

In other words: Open=VCS less than 0.1V

Internally, when an encoder pin is “open,” it truly is open. Such condition is electrically the same as an LED failing open, and such condition can therefore be detected confidently.

However, when an encoder pin is “short,” there is some internal resistance to the encoder that must be modeled (i.e., accounted for). In one exemplary embodiment, the datasheet specifies the internal resistance to be a maximum of 10 ohms. There is also some internal resistance to the low side of the matrix driver that must be included. The high side of the matrix driver has a voltage drop due to switching components so voltage driving the LEDs must be reduced as well.

Per an alternative approach for addressing the subject matter in a different way, the common pin on the encoder can be tied to a SC low side of the matrix driver and the remaining pins could be tiled SW high sides of the matrix driver. Also, resistors may be placed in series with any of the pins on the encoder as long as their values are selected so as to still meet the detection criteria of the matrix driver.

A number of light emitting diode (LED) matrix driver integrated circuits have fault detection capabilities where the matrix driver is able to detect if an LED has failed open or short. This detection is done without any additional external components. Many encoders use a “grey code” in order to communicate position. The grey code is achieved by the encoder having a pin tied to a common reference point that each of the remaining pins are referenced to. The remaining pins are either open or short, depending on the encoder position, effectively acting as a bit. Each encoder position has a unique sequence of bits that can be read electrically, thus communicating the position of the encoder. The LED matrix driver is able to detect the open and short conditions of the pins and communicate the position to the microcontroller.

Using the presently disclosed subject matter, no additional external components are needed to effectively read encoder position. Also, pulse and reach synchronization burden are removed from the microcontroller.

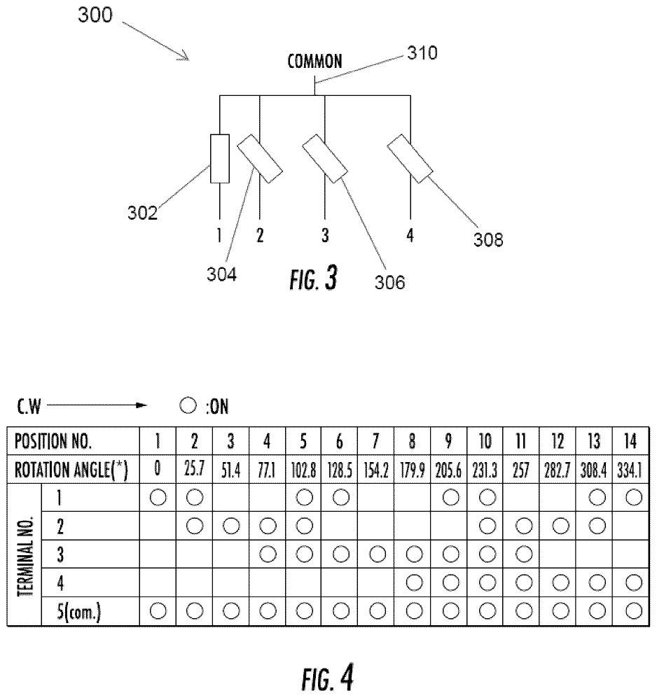

FIG. 3 provides a schematic block diagram of an exemplary arrangement of pins of an exemplary encoder (generally 300) in accordance with an exemplary embodiment of the present disclosure. FIG. 4 provides a table-form chart of rotational angle positions respectively represented by a grey code implemented with a four pin (or terminal) plus common terminal arrangement of an exemplary encoder (generally 300, FIG. 3) in accordance with an exemplary embodiment of the present disclosure.

More specifically, FIG. 3 illustrates as an example an encoder 300 in a designated position 1, which shows per the chart of FIG. 4 as equating to pin 1 of the device (pin 302 of FIG. 3) as in the “short” state (along with the common pin 310 of FIG. 3), while pins 2 through 4 (pins 304, 306, and 308, respectively, of FIG. 3) are in the “open” state. The chart of FIG. 4 designates a short condition by an enclosed circle within the chart square, and designates an open condition by a blank square. As noted in the chart of FIG. 4, designated position 1 equates in this exemplary embodiment to a rotational angle. With fourteen different positions per the example, the rotational angle between adjacent position numbers amounts to a full 360 degrees divided by the number of positions (fourteen). Other numbers of positions may be practiced, resulting in different rotational angles spread over the full degree of rotation, and involving a different set of corresponding grey code indications.

In the past, the data interface of a microcontroller has read encoder position using a shift register to “pulse” each pin on the encoder sequentially, and then read back the position to a single pin on the microcontroller (UC_ENCODER_SINK) that is tied to the common pin on the encoder. Using such prior design, the microcontroller could control the timing of the shift register pin pulses to accurately read each pin. The shift register was also mainly used to drive LEDs.

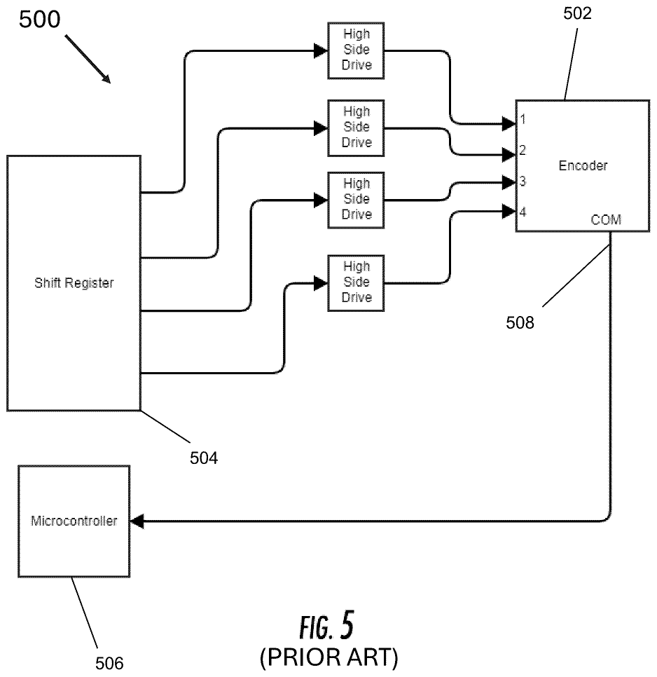

More specifically, FIG. 5 provides a schematic block diagram generally 500 of one exemplary cycle selector encoder 502 and shift register 504 and an exemplary microcontroller 506 of an exemplary prior art arrangement. Shift register 504 is controllably used to “pulse” each of pins (pins 1, 2, 3, and 4) on the encoder 502 sequentially, to read the encoder position. The position is then read back to a single pin on the microcontroller 506 that is tied to the common pin 508 on the encoder 502.

In some desired embodiments, in order to drive the number of LEDs needed, two shift registers including all of their associated external components may be needed, and at a cost which is greater than a simple LED matrix driver solution as disclosed herewith. The LED matrix driver-based approach also has an added benefit of taking up significantly less space in layout and using fewer external components by controlling both the high and low side internally. However, a matrix driver is more autonomous than a shift register. Thus, even though an encoder could be pulsed using similar circuitry as for pulsing the shift register, it is not immediately apparent that accurate synchronization could be achieved between the matrix driver pulses to the encoder and the microcontroller pin.

However, in accordance with presently disclosed subject matter, synchronization can be achieved and the encoder position can be read, using the open short detection internal to the matrix driver.

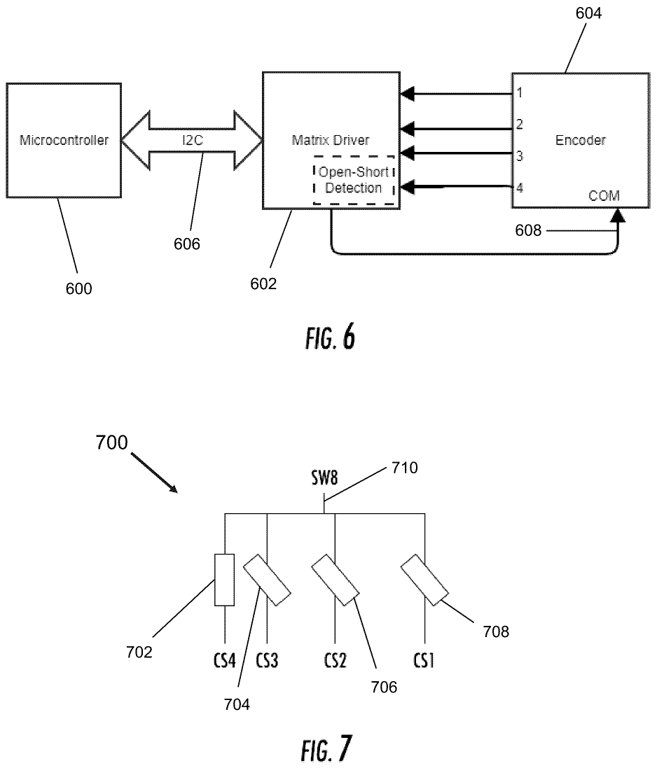

FIG. 6 provides a schematic block diagram of the communication relationship of an exemplary microcontroller 600, an exemplary matrix driver 602, and an exemplary encoder 604 in accordance with exemplary aspects of the present disclosure. In particular, microcontroller 600 and matrix driver 602 may communicate via a communications bus 606, such as through an I2C bus, and/or wired or wireless communications link. As noted above, microcontroller 600 may first communicate with matrix driver 602 via the communications bus 606, to request the matrix driver 602 to check with encoder 604 for opens and shorts. Voltages on specific pins are read by the matrix driver 602 to detect an open or short condition. The open or short conditions creates a corresponding combination of 1's and 0's which are shared with the microcontroller 600. The combinations of open and short conditions on designated pins form a grey code, which determines the corresponding position of the user input to the associated controller. The matrix driver 602 handles the voltage determinations to create the grey code, and timing is also done by the LED matrix driver 602, thus reducing software complexity for the microcontroller 600. Additionally, no external components are needed, which also helps reduce cost.

In the presently disclosed subject matter, the microcontroller 600 specifically requests that the matrix driver 602 check for opens and shorts. This request is made periodically through the I2C bus 606 and the matrix driver 602 returns the open and short locations through the same I2C bus 606. In this example the CS nets are the “low” sides of the matrix driver 602 and SW are the “high” sides. The voltage on the CS pins is read by the matrix driver 602 and used to detect the open or short condition. As otherwise noted herein, the original encoder 604 polarity relative to common pin 608 is still valid for some embodiments, but in some instances polarity can be changed (reversed) as indicated to accommodate various layout needs. It is important to note that certain pins may be used to ground the body of the encoder 604 for ESD (electrostatic discharge) matters which form no particular aspect of the presently disclosed subject matter.

FIG. 7 provides a schematic block diagram of an exemplary arrangement of CS pins of an exemplary encoder (generally 700) in accordance with an exemplary embodiment of the present disclosure.

More specifically, FIG. 7 illustrates as an example an encoder 700 in an exemplary position 1, which shows the feature equating to pin 1 of the device (pin 702) as in the “short” state (along with the common pin 710), while pins 2 through 4 (pins 704, 706, and 708, respectively, of FIG. 7) are in the “open” state.

As referenced above, alternative embodiments could involve that the common pin on the encoder be tied to a CS low side of the matrix driver while the remaining pins are tied to SW high sides of the matrix driver. Circuitry can be adjusted as needed to establish desired detection values. For example, resistors may be placed in series with any of the pins on the encoder 700 (FIG. 7) as long as their values were selected to still meet the detection criteria of the matrix driver.

In the case of embodiments relating to a laundry appliance (whether washer, dryer, or other), the exemplary encoder 700 of FIG. 7 may be considered a cycle selector encoder, whereby a user designates what cycle is to be run by the appliance. It is to be understood that the position detection or determining subject matter presently disclosed can be used in conjunction with other contexts than just use with appliances. All such variations or alternative implementations are intended to come within the broader scope of disclosure herewith.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance, comprising:
a cabinet, the cabinet comprising a user interface panel, the user interface panel comprising a display and an input selector;
an operational component configured to perform a cycle;
a controller communicatively coupled to the operational component, the controller configured to receive a user input for operating the operational component; and
a matrix driver operably coupled to the input selector and communicatively coupled to the controller, and configured to receive a user input for operating the operational component and to provide to the controller a signal corresponding to the user input.

2. The appliance of claim 1, wherein the input selector is configured to assume a rotational position based on the user input, and includes a position encoder with selected pins configured to output open or short fault detection voltages on the selected pins depending on the rotational position based on the user input.

3. The appliance of claim 2, wherein the matrix driver comprises an LED matrix driver which is configured to read voltages on the selected pins of the position encoder to detect respective open or short conditions, and to output a grey code based on the detected conditions, which grey code indicates a unique rotational position corresponding with a selected cycle to be performed.

4. The appliance of claim 3, wherein:
the matrix driver and the controller communicate via a communications bus;
the controller is configured to request the matrix driver to check for open and short conditions on the selected pins of the position encoder, and to control the operational component to perform the cycle selected by the user input.

5. The appliance of claim 4, wherein the communications bus comprises one of an Inter-Integrated Circuit (I2C) bus, a Serial Peripheral Interface (SPI), or other serial bus.

6. The appliance of claim 4, wherein:
the communications bus comprises at least one of a wired or a wireless communications link; and
the controller comprises a microcontroller.

7. The appliance of claim 1, wherein the appliance comprises at least one of a washing machine appliance, a dryer appliance, or a cooktop appliance.

8. A method for controlling an appliance, comprising:
providing an appliance having
a cabinet, the cabinet comprising a user interface panel, the user interface panel comprising a display and an input selector,
an operational component configured to perform a cycle,
a controller communicatively coupled to the operational component, and
a matrix driver operably coupled to the input selector and communicatively coupled to the controller,
receiving a user input at the input selector for operating the operational component; and
using the matrix driver to detect a rotational position of the input selector corresponding with a cycle selected by the user input, and to output to the controller a signal corresponding to the user input.

9. The method of claim 8, wherein the input selector is configured to assume a rotational position based on the user input, and includes a position encoder with selected pins configured to output open or short fault detection voltages on the selected pins depending on the rotational position based on the user input.

10. The method of claim 9, wherein the matrix driver comprises an LED matrix driver which is configured to read voltages on the selected pins of the position encoder to detect respective open or short conditions, and to output a grey code based on the detected conditions, which grey code indicates a unique rotational position corresponding with a selected cycle to be performed.

11. The method of claim 10, wherein:
the matrix driver and the controller communicate via a communications bus;
the controller is configured to request the matrix driver to check for open and short conditions on the selected pins of the position encoder, and to control the operational component to perform the cycle selected by the user input.

12. The method of claim 11, wherein the communications bus comprises an Inter-Integrated Circuit (I2C) bus.

13. The method of claim 11, wherein:
the communications bus comprises at least one of a wired or a wireless communications link; and
the controller comprises a microcontroller.

14. The method of claim 8, wherein the appliance comprises at least one of a washing machine appliance, a dryer appliance, or a cooktop appliance.

15. A laundry appliance, comprising:
a cabinet, the cabinet comprising a user interface panel, the user interface panel comprising a display and an input selector;
an operational component configured to perform a cycle;
a controller communicatively coupled to the operational component, the controller configured to receive a user input for operating the operational component; and
an LED matrix driver operably coupled to the input selector and communicatively coupled to the controller, and configured to receive a user input for operating the operational component and to provide to the controller a signal corresponding to the user input;
wherein the input selector is configured to assume a rotational position based on the user input, and includes a position encoder with selected pins configured to output open or short fault detection voltages on the selected pins depending on the rotational position based on the user input; and
the LED matrix driver is configured to read voltages on the selected pins of the position encoder to detect respective open or short conditions, and to output a grey code based on the detected conditions, which grey code indicates a unique rotational position corresponding with a selected cycle to be performed.

16. The laundry appliance of claim 15, wherein the controller is configured to request the matrix driver to check for open and short conditions on the selected pins of the position encoder, and to control the operational component to perform the cycle selected by the user input.

17. The laundry appliance of claim 15, wherein:
the matrix driver and the controller communicate via a communications bus;

18. The laundry appliance of claim 17, wherein the communications bus comprises one of an Inter-Integrated Circuit (I2C) bus, a Serial Peripheral Interface (SPI), or other serial bus.

19. The laundry appliance of claim 17, wherein:
the communications bus comprises at least one of a wired or a wireless communications link; and
the controller comprises a microcontroller.

20. The laundry appliance of claim 15, wherein the laundry appliance comprises at least one of a washing machine appliance or a dryer appliance.
